(19) United States
(12) Patent Application Publication
(10) Pub. No.: US 2008/0059429 A1
(43) Pub. Date: Mar. 6, 2008

(54) Integrated search processing method and device

(76) Inventors: Go Kojima, Yamato (JP); Tetsuo Tanaka, Yamato (JP)

Correspondence Address: MCDERMOTT WILL & EMERY LLP, 600 13TH STREET, N.W., WASHINGTON, DC, 20005-3096, US

(21) Appl. No.: 11/515,386

(22) Filed: Sep. 5, 2006

(51) Int. Cl. G06F 17/30

(52) U.S. Cl. 707/3

(57) ABSTRACT

A system capable of searching information provided by multiple databases and WWW servers as if the information were stored in multiple tables of a single database, and an environment which allows easy installation of the system, are provided to a user. An integrated search processing device holds definition information obtained by defining: information used for accessing the WWW servers and databases, and schema information on data held therein. The integrated search processing device uses the definition information to provide: a table selection screen which allows selection of tables to be searched; a search condition input screen used for inputting a search condition for the tables selected through the table selection screen; and a result screen which displays a result of search processing performed based on information inputted through the search condition input screen and the definition information, thereby defining respective operations of the integrated search processing device.

### BACKGROUND OF THE INVENTION

The present invention relates to a heterogeneous data source access technique which allows a user to effectively perform an integrated search of a plurality of databases and information held by a plurality of World Wide Web (WWW) servers without thinking of a difference between objects to be searched.

In a network such as the Internet, application services are provided using the WWW as a user interface. With the use of the WWW, a special client program is not required for each application, and any application using the WWW can be used as long as there is a WWW browser. However, even if an individual application using the WWW handles data items common to applications, there is no system for combining data items between the applications. Thus, when data items are mutually used between the applications, a user needs to open a different window of the WWW browser for each of the applications and input the data items in each window.

In order to deal with the problem, a system for providing a combined page, as a user interface, into which a plurality of WWW pages are combined, is disclosed (for example, see Japanese Patent Laid-Open Publication No. 2003-345697 (hereinafter, referred to as Patent Document 1)). In this system, the combined page is provided by the following procedure. WWW servers providing existing WWW pages that are defined as targets of a combined page are accessed to obtain those WWW pages therefrom. Each of the WWW pages is analyzed according to a predefined procedure and necessary data is extracted therefrom in a data format having a predetermined structure. According to a predefined combined-page outputting step, the combined page is generated using the extracted data. In generating the combined page, if there is a data item common to the WWW pages defined as targets, a table may be generated by merging the WWW pages using the common data item as a key and outputted in the combined page.

With this method, data included in a plurality of WWW pages can be used as a data item which composes one combined page. If the data item common to the WWW pages and composing the combined page is included, a table generated by merging tables having that common data item and held in the WWW pages may be displayed in the combined page. Further, since data included in the existing WWW pages can be used as a data item used to generate a combined page, it is possible to provide a combined page having a flexible layout irrespective of the layouts of the existing WWW pages.

There are cases where information handled by a company or the like is managed using a plurality of databases. It is often inconvenient if related information is managed across the plurality of databases.

To deal with this problem, a database retrieval system is disclosed in which a table can be composed by combining a plurality of tables of databases (for example, see Japanese Patent Laid-Open Publication No. 2001-236363 (hereinafter, referred to as Patent Document 2)). With this system, an access object which is used to access a database to be searched is provided for a client program. By using the access object, a desired database can be searched among a plurality of databases, thereby making it possible to realize an integrated search of a plurality of databases.

As mentioned above, a combined user interface-providing device allows a user to use a plurality of WWW pages in a combined manner by merely accessing only one page. A database combining device allows the user to perform an integrated search of information included in a plurality of databases in the same way as when the user handles one table.

With the systems mentioned above, combining a plurality of WWW pages and combining a plurality of databases can be performed, but an integrated search of information held in WWW pages and databases cannot be performed.

In many cases, however, a company manages information related to the business by using a database server and by accessing the information via a WWW application on an intranet or on the Internet.

Under these circumstances, an environment is required in which databases held by database servers and information handled by WWW applications can be integrally searched. However, there is no configuration capable of handling both the databases and the information with each having a different data structure. Thus, heretofore, there has been no alternative to developing a program or system for realizing an interface which can handle the difference between their data structures and access the database and the information by performing coding according to the format and schema of each of the database and information held by the WWW server.

Information can be retrieved by extracting necessary information from a WWW page using the technique described in Patent Document 1 and mixing the extracted information with a combined table generated from a plurality of databases using the technique described in Patent Document 2. However, to obtain the above-mentioned environment, it is necessary to develop a screen used for integrally searching WWW pages and databases, and to develop software for realizing processing of: executing a desired search of each of the WWW pages and the databases according to information inputted via the screen; extracting necessary information therefrom; combining the information extracted from the WWW pages and the information extracted from the databases without distinguishing therebetween; and outputting the combined information as a search result on the screen. Such software development generally requires performing coding following each of the data formats and search processing methods used in the WWW pages. This is hard work requiring cost and time.

### SUMMARY OF THE INVENTION

It is therefore an object of the present invention to provide an environment with a simple configuration in which a user can integrally search a plurality of WWW pages and a plurality of databases without thinking of the difference between their data structures.

An integrated search processing device according to the present invention holds, in advance, definition information composed of information used for accessing a WWW server and a database and schema information of data held by the WWW server and held in the database, and defines operations of the integrated search processing device using the definition information.

Specifically, according to an aspect of the present invention, an integrated search processing device connected to a client, a plurality of databases, and a plurality of WWW servers, are provided, including:

a definition information holding unit which holds definition information including: information which is used for connecting to the plurality of databases; configuration information on tables held by the plurality of databases; information which is used for connecting to the plurality of WWW servers; and configuration information on information held by the plurality of WWW servers;

an input screen generating unit which generates a table selection screen which is used for receiving from a user a selection of tables that can be integrally searched by using the definition information in response to a first request for a search made from the client, and which is to be displayed on a display device provided to the client that has made the first request, sends the table selection screen to the client that has made the first request, further generates a search condition input screen which is used for inputting a search condition for the selected tables by using the definition information in response to a second request from the client that has received a selection instruction from the user via the table selection screen, and which is to be displayed on a display device provided to the client that has made the second request, and further sends the search condition input screen to the client that has made the second request;

a request processing unit which generates a request command to request the search by using the definition information in response to a third request for the search from the client that has received an input of the search condition from the user via the search condition input screen, and sends the request command to the plurality of WWW servers and the plurality of databases which hold the tables to be searched;

a reader unit which converts, if the tables to be searched are held by the plurality of WWW servers, a search result returned in response to the request command into a format that allows a merge processing;

an intermediate data holding unit which holds, if the tables to be searched are held by the plurality of databases, the search result returned in response to the request command, and further holds, if the tables to be searched are held by the plurality of databases WWW servers, the search result that has been converted by the reader unit;

a merge processing unit which performs the merge processing on information held in the intermediate data holding unit according to a condition specified in the third request; and

a result screen generating unit which generates screen data which is used for displaying a result of the merge processing performed by the merge processing unit on the display device provided to the client that has made the third request, and sends the screen data to the client that that has made the third request.

According to the present invention, it is possible to provide an environment with a simple configuration in which a user can integrally search a plurality of WWW pages and a plurality of databases without thinking of the difference between their data structures.

### BRIEF DESCRIPTION OF THE DRAWINGS

In the accompanying drawings:

FIG. 1 is a functional block diagram showing an entire network system according to an embodiment;

FIGS. 2A and 2B show examples of tables included in a database held by a DBMS according to the embodiment;

FIG. 3 shows an example of information held by a WWW server according to the embodiment;

FIG. 4 shows an example of definition information according to the embodiment;

FIG. 5 shows an example of a table selection screen according to the embodiment;

FIG. 6 shows an example of a search condition input screen according to the embodiment;

FIG. 7 is a flow describing a process procedure of an integrated search processing device according to the embodiment;

FIGS. 8A and 8B show examples of tables held in an intermediate data holding unit as request results according to the embodiment;

FIG. 9 shows an example of a merge result according to the embodiment; and

FIG. 10 shows another example of the merge result converted into an HTML document format, according to the embodiment.

### DESCRIPTION OF THE PREFERRED EMBODIMENTS

### First Embodiment

Hereinafter, a first embodiment of the present invention will be described with reference to the accompanying drawings.

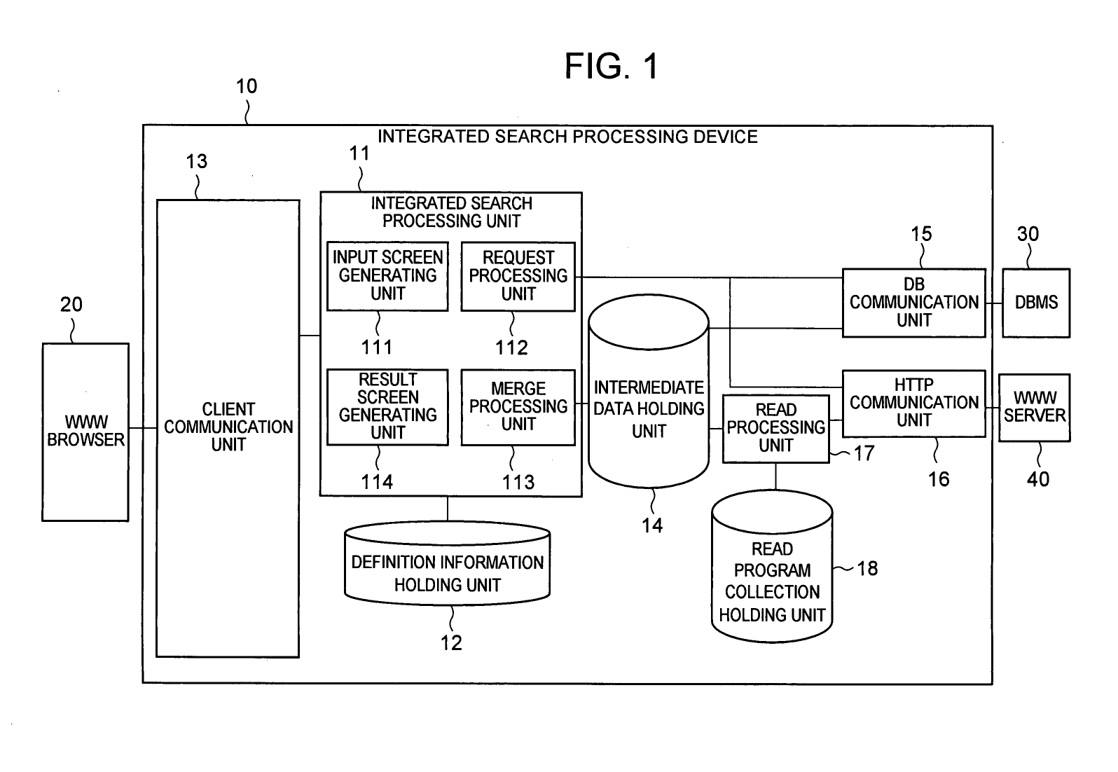

First, a description is given of an entire configuration of a network system according to this embodiment, with reference to FIG. 1. FIG. 1 is a functional block diagram showing the entire network system of this embodiment.

The network system of this embodiment includes a plurality of information processors connected to a network, i.e., an integrated search processing device 10, a WWW browser 20, a database management server (DBMS) 30, and a WWW server 40.

In response to a request from the WWW browser 20 serving as a client, the integrated search processing device 10 provides the WWW browser 20 with an environment in which information provided by a plurality of databases and WWW applications can be integrally searched without distinguishing between the databases and WWW applications, and with a result of the search.

The WWW browser 20 is composed of one or more information processors each having a WWW browser installed therein.

The DBMS 30 manages one or more databases, and upon reception of an SQL statement, searches a database held therein according to a condition specified in the SQL statement and returns a result of the search.

The WWW server 40 holds one or more WWW pages, and returns a corresponding HTML document in response to a request from the WWW browser 20.

The integrated search processing device 10, the WWW browser 20, the database management server (DBMS) 30, and the WWW server 40 have a hardware configuration (including a CPU, a memory, and a hard disk having a program installed therein) which is included in an ordinary information processor and is necessary to execute the program that realizes the respective function.

Next, a functional configuration of the integrated search processing device 10 is described.

The integrated search processing device 10 includes an integrated search processing unit 11, a definition information holding unit 12, a client communication unit 13, an intermediate data holding unit 14, a database (DB) communication unit 15, an HTTP communication unit 16, a read processing unit 17, and a read program collection holding unit 18.

The integrated search processing unit 11 executes main processing (i.e., integrated search processing) of this embodiment. The integrated search processing unit 11 includes: an input screen generating unit 111 which generates an HTML document (HTML format) to be used for an input screen which receives input from a user with the WWW browser 20, based on request information, which is information on a request sent from the WWW browser 20 and information held in the definition information holding unit 12; a request processing unit 112 which generates and sends requests to the DBMS 30 and the WWW server 40 to be searched, based on request information sent from the WWW browser 20 and the information held in the definition information holding unit 12; a merge processing unit 113 which receives and merges results of the sent requests; and a result screen generating unit 114 which generates an HTML document to be used for a result screen, using information merged by the merge processing unit 113, based on the information held in the definition information holding unit 12.

The definition information holding unit 12 holds schema information of tables held by the DBMS 30 to be searched and definition of information held by the WWW server 40 to be searched.

The DB communication unit 15 acts as an interface with the DBMS 30. If the integrated search processing unit 11 generates and sends a request to search a database held by the DBMS 30 to the DB communication unit 15, the DB communication unit 15 issues to the DBMS 30 a SQL statement based on the request, and also receives a result of the SQL statement from the DBMS 30 and stores the result in the intermediate data holding unit 14.

The HTTP communication unit 16 acts as an interface with the WWW server 40. If the integrated search processing unit 11 generates and sends a request for information held by the WWW server 40 to the HTTP communication unit 16, the HTTP communication unit 16 generates an HTTP request based on the request and sends the HTTP request to the WWW server 40, and also receives a result of the HTTP request.

The client communication unit 13 acts as an interface with the WWW browser 20. Upon reception of a request sent from the WWW browser 20, the client communication unit 13 passes the request to the integrated search processing unit 11, and returns to the WWW browser 20, which is a request source, an HTML document to be used for displaying an input screen or a result screen which is obtained through the processing of the integrated search processing unit 11.

The read processing unit 17 analyzes the result of the HTTP request, the result being received by the HTTP communication unit 16 from the WWW server 40, and stores the result as data having a table format in the intermediate data holding unit 14.

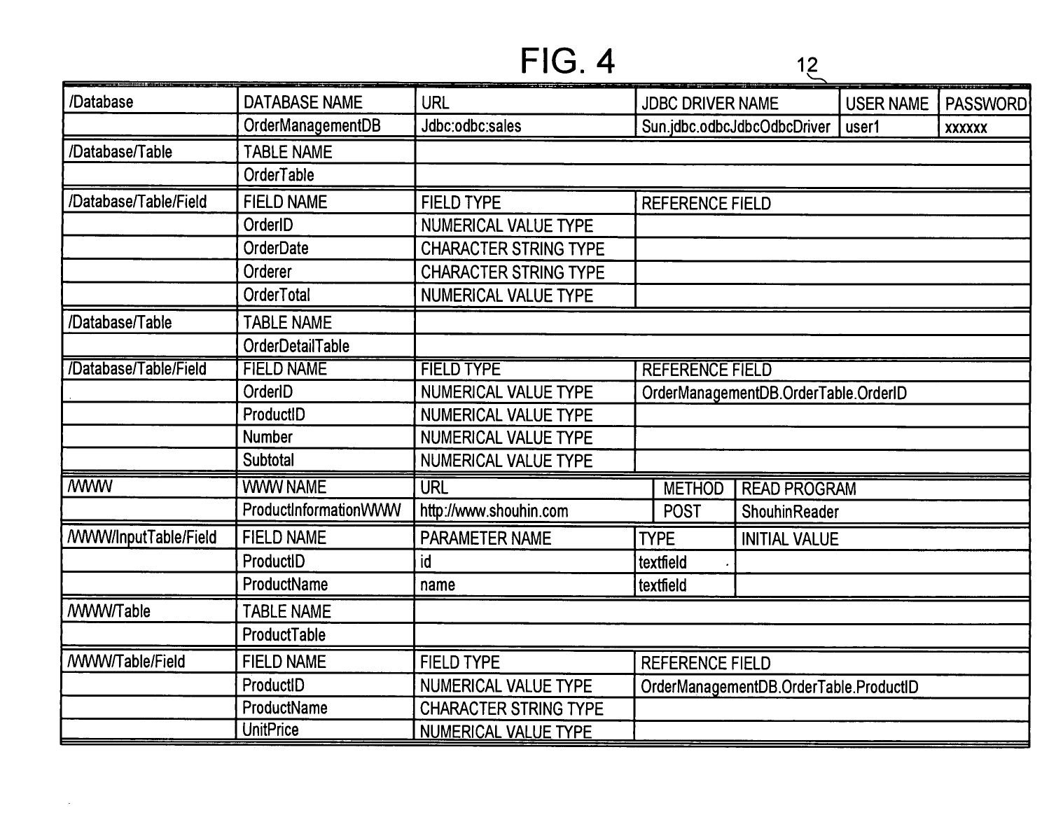

The read processing unit 17 is realized when the CPU selects, according to the information held in the definition information holding unit 12, a proper read program from the read program collection holding unit 18 to be described later, and executes the selected read program. For example, in an example of the information held in the definition information holding unit 12 shown in FIG. 4, to be described later, the read processing unit 17 is realized when the read program (in the example of FIG. 4, “ShouhinReader”) held in the read program column of the information record whose WWW name is “ProductInformationWWW” is loaded from the read program collection holding unit 18 and executed by the CPU. If the read processing unit 17 is implemented with the Java (registered trademark) language, the read programs and the read program collection holding unit 18 are implemented by a Java class and a jar file (class library), respectively.

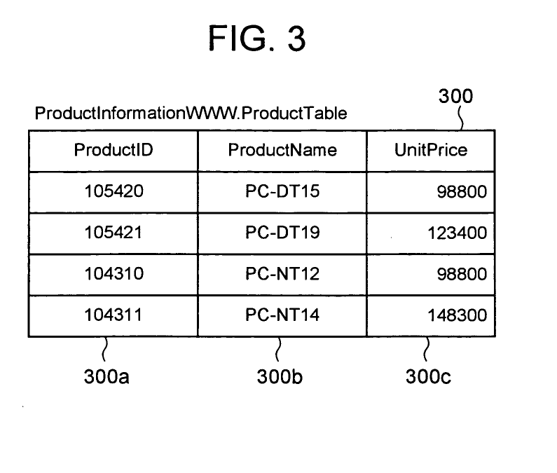

As described above, the read processing unit 17 has a function of extracting data having an HTML document format, as data having a table format. In order to handle information held by the WWW server 40 as information having a table format, a method disclosed in Patent Document 1 is used, in which necessary information is extracted from an HTML document in the form of a table. How to implement and process this function is also described in Patent Document 1 in detail. For example, if an object to be searched is “ProductInformationWWW” (which is defined in FIG. 4 as the WWW page that can be accessed by a uniform resource locator (URL), http://www.shouhin.com) which is the WWW page name of the information record of “/WWW” in the example of FIG. 4, the read processing unit 17 has the function of analyzing an HTML document including product information, provided by the WWW server 40 and of extracting therefrom information in the form of a table, i.e., ProductInformationWWW.ProductTable 300, shown in FIG. 3, to be described later.

The read program collection holding unit 18 holds read programs each of which realizes the read processing unit 17.

The intermediate data holding unit 14 temporarily stores a process result received by the DB communication unit 15 from the DBMS 30 and a process result received by the HTTP communication unit 16 from the WWW server 40 and analyzed by the read processing unit 17. The data (in a table format) held in the intermediate data holding unit 14 is used when the merge processing unit 113 performs merge processing according to the information held in the definition information holding unit 12. In addition, the data is directly used when the result screen generating unit 114 generates an HTML document to be used for displaying a result screen. To implement the intermediate data holding unit 14, a database, an object program, or the like can be used. However, any implementation method can be used as long as it has a function of temporarily storing and of extracting data in a table format as described above.

With the functional configuration described above, in response to a request sent from the WWW browser 20, the integrated search processing device 10 uses the information held in the definition information holding unit 12 thereof to extract information obtained from the DBMS 30 and the WWW server 40 in the intermediate data holding unit 14, merges the information to generate an HTML document to be used for displaying a result screen, and returns the generated HTML document to the WWW browser 20.

Next, tables included in a database held by the DBMS 30 and information held by the WWW server 40 are described.

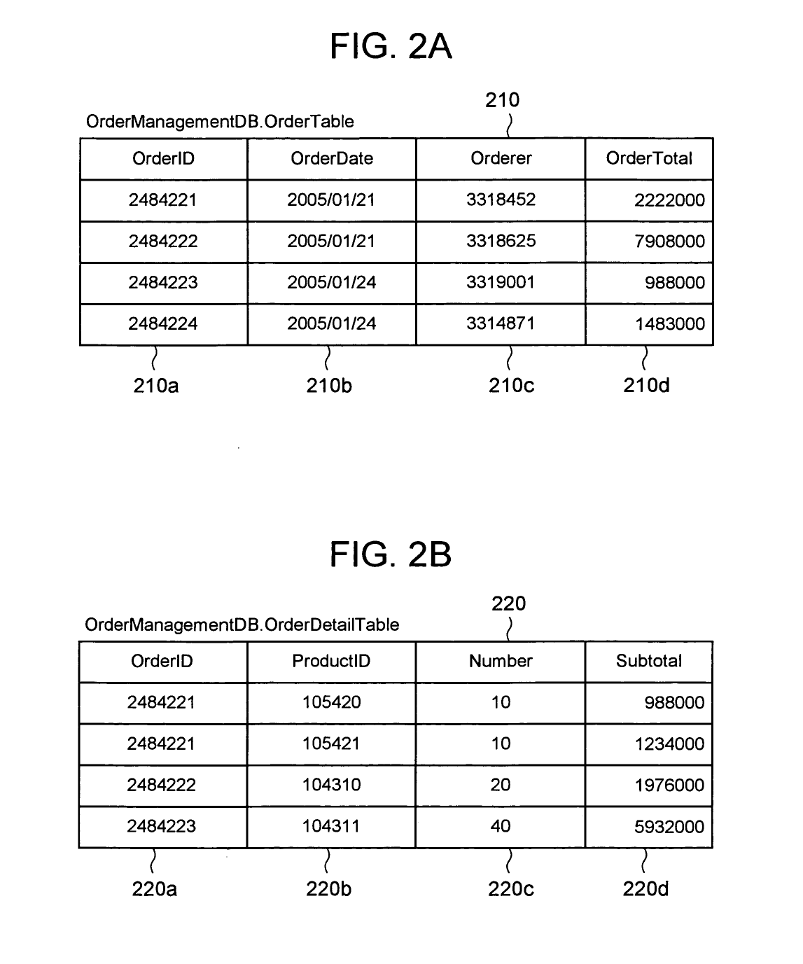

FIGS. 2A and 2B show examples of tables included in the database held by the DBMS 30. In this embodiment, it is assumed that the DBMS 30 manages a database (i.e., order management database) necessary for order management in which orders are managed in a company. A description is given of an example case in which the order management database includes two tables, i.e., an order table 210 and an order detail table 220. Hereinafter, in this specification, the order table 210 of the order management database is referred to as “OrderManagementDB.OrderTable 210”, and the order detail table 220 of the order management database is referred to as “OrderManagementDB.OrderDetailTable 220”.

The OrderManagementDB.OrderTable 210 includes an OrderID field 210a, an OrderDate field 210b, an Orderer field 210c, and an OrderTotal field 210d. The OrderManagementDB.OrderDetailTable 220 includes an OrderID field 220a, a ProductID field 220b, a Number field 220c, and a Subtotal field 220d.

FIG. 3 shows an example of the information held by the WWW server 40. In this embodiment, it is assumed that the WWW server 40 manages information of products handled by a company, and holds a product table 300. Hereinafter, in this specification, the product table 300 held by the WWW server 40, which manages information of products, is referred to as “ProductInformationWWW.ProductTable 300”. The ProductInformationWWW.ProductTable 300 stores records each specified by a ProductID field 300a, a ProductName field 300b, and a UnitPrice field 300c.

Note that the WWW server 40 generally returns a result in the HTML document format in response to a search request from the WWW browser 20. In this embodiment, the read processing unit 17 uses a read program held in the read program collection holding unit 18 to extract the returned result having data in the HTML document format as data in a table format. How to implement and process this operation is described in detail in Patent Document 1, so a description thereof is omitted here.

Next, information held in the definition information holding unit 12 is described. FIG. 4 shows an example of the information held in the definition information holding unit 12. The definition information holding unit 12 defines and holds information used to access databases held by the DBMS 30 and to access the WWW server 40 and schema information of data held by the DBMS 30 and the WWW server 40. The integrated search processing unit 11 uses the information held in the definition information holding unit 12 to define each operation of the integrated search processing device 10.

As shown in FIG. 4, the network system of this embodiment holds, as information held in the definition information holding unit 12, a uniform resource locator (URL) serving as information to connect to (i.e., access) the DBMS 30 to be searched and schema information of each table held by the DBMS 30 in advance. The schema information includes: the name of a table held in the database to be searched; and, for each table, field names serving as configuration information of the table, the field type of each field, and a reference field of each field. Definition information for the WWW server 40 includes: for each WWW page to be searched, a URL serving as information to connect to (i.e., access) the WWW page, a method, a read program; and, when the WWW server 40 holds a table, the name of the table, field names serving as configuration information of the table, the field type of each field, and a reference field of each field.

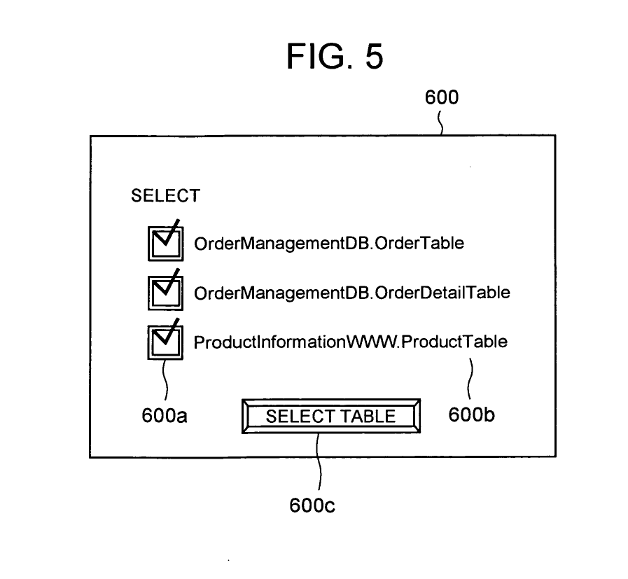

FIG. 5 shows an example of a table selection screen 600. The table selection screen 600 is displayed on a display device of the WWW browser 20, and displays, to a user, a list of tables that can be integrally searched by the user and receives a selection of tables to be integrally searched. After the input screen generating unit 111 generates an HTML document in response to an instruction from the user and sends the HTML document to the WWW browser 20, the table selection screen 600 is displayed on the display device of the WWW browser 20.

To generate the HTML document to be used for the table selection screen 600, information held in the definition information holding unit 12 is consulted to extract therefrom names of tables defined as tables in the information held in the definition information holding unit 12, and to generate data constituting the table selection screen 600 from which tables can be selected.

As shown in FIG. 5, the table selection screen 600 includes a selection reception column 600a which includes check boxes used for receiving a selection, a table name display column 600b which displays the name of each table, and a table selection button 600c which receives an instruction to send selected information to the integrated search processing device 10.

The example of FIG. 5 shows a state in which the OrderManagementDB.OrderTable 210, the OrderManagementDB.OrderDetailTable 220, and the ProductInformationWWW.ProductTable 300, which are defined as tables in the information held in the definition information holding unit 12 shown in FIG. 4, are displayed in the table name display column 600b as selectable tables, and all of the tables are selected in the selection reception column 600a as tables to be searched.

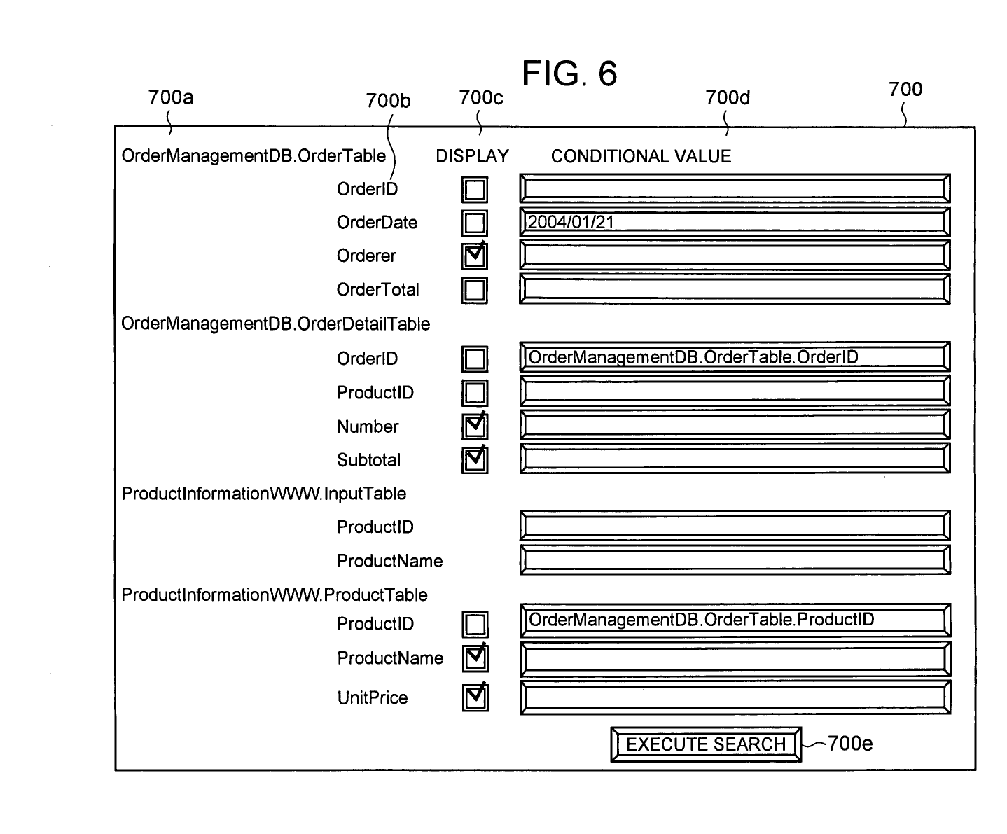

FIG. 6 shows an example of a search condition input screen 700. The search condition input screen 700 is used to input search conditions for each table selected by the user.

As shown in FIG. 6, the search condition input screen 700 includes a name display section 700a which displays the name of each table selected via the table selection screen 600, an item display section 700b which displays the names of fields included in each table, a display item selection column 700c which includes check boxes used for receiving a selection of a field to be displayed after search, a condition input column 700d which receives an input of a search condition, and a search execution button 700e which receives an instruction to send the inputted information to the integrated search processing device 10. The user can set the display or nondisplay of fields included in each table and input a condition value via the search condition input screen 700.

If information held by the WWW server 40 is searched, an HTTP request parameter used for accessing the WWW server 40, which holds WWW pages to be searched, can also be inputted in the condition input column 700d. In this embodiment, the HTTP request parameter is expressed as the ProductInformationWWW.InputTable. The HTTP request parameter is prepared as data used for generating a screen used to input a search condition, in order to search the WWW pages (HTML documents) held by the WWW server 40 for data.

In general, in response to a search request, a WWW server uses data prepared as an input table to generate an HTML document to be used for inputting a search condition, and provides a user with a screen used to input a search condition. The user can specify only fields prepared as fields of the input table, to be searched, merged, sorted, or the like.

In this embodiment, the definition information holding unit 12 also holds configuration information about the input table. However, an HTML document is generated such that fields other than those that can be specified in the input table can also be specified via the search condition input screen 700.

When an HTML document used for displaying the search condition input screen 700 is generated, the input screen generating unit 111 identifies selected tables from a request received via the client communication unit 13, reads configuration information about the identified tables from information held in the definition information holding unit 12, and generates data to be placed in each of the name display section 700a, the item display section 700b, the display item selection column 700c, and the condition input column 700d.

If a selected table is included in a WWW page, the input screen generating unit 111 also generates input columns for the fields shown in the input table as the HTTP request parameters with respect to the WWW server 40.

As described above, a screen used for sending a request to the WWW server 40 is given by an HTML document provided by the WWW server 40. When the user performs a desired input to the form in the given HTML document, request parameters are set. To allow inputting to the fields of the input table to be performed in the same way as the inputting to the form, type information is specified in each column of the input table included in the information held in the definition information holding unit 12, and the style of the form can be changed according to the type information. The type indicates the type of an input field and includes “textarea”, “textfield”, “checkbox”, and “radiobox”. In the example of the information held in the definition information holding unit 12, “textfield” is set to both two fields in the input table. If “textarea” is set, the fields are each displayed in the form of a text area in which a plurality of lines of text can be inputted, and if “checkbox” is set, the fields are each displayed in the form of a check box in which selection or nonselection can be specified. Further, if “select” is set, a list is displayed in each of the fields, from which a value can be selected from among a plurality of selectable items. The selectable items are set as initial values in a list in advance.

Note that if an initial value has been set in the reference field column corresponding to each field of each table in the information held in the definition information holding unit 12, the condition input column 700d includes the initial value inputted therein.

In the example of the information held in the definition information holding unit 12, OrderManagementDB.OrderTable.OrderID is set as an initial value in the reference field column corresponding to the OrderID field 220a of the OrderManagementDB.OrderDetailTable 220. This indicates that the OrderID field 220a of the OrderManagementDB.OrderDetailTable 220 refers to, or in other words, has a reference relationship with, the OrderID field 210a of the OrderManagementDB.OrderTable 210. When such a reference character string is inputted in the condition input column 700d of the search condition input screen 700, the merge processing unit 113 merges results based on the reference relationship.

In the example of the information held in the definition information holding unit 12 shown in FIG. 4, the ProductID field 300a of the ProductInformationWWW.ProductTable 300 has a similar reference relationship with the ProductID field 220b of the OrderManagementDB.OrderDetailTable 220. The reference relationship is displayed in the condition input column 700d corresponding to the ProductID field of the ProductTable in the search condition input screen 700.

Next, a description is given of a process procedure of the integrated search processing device 10.

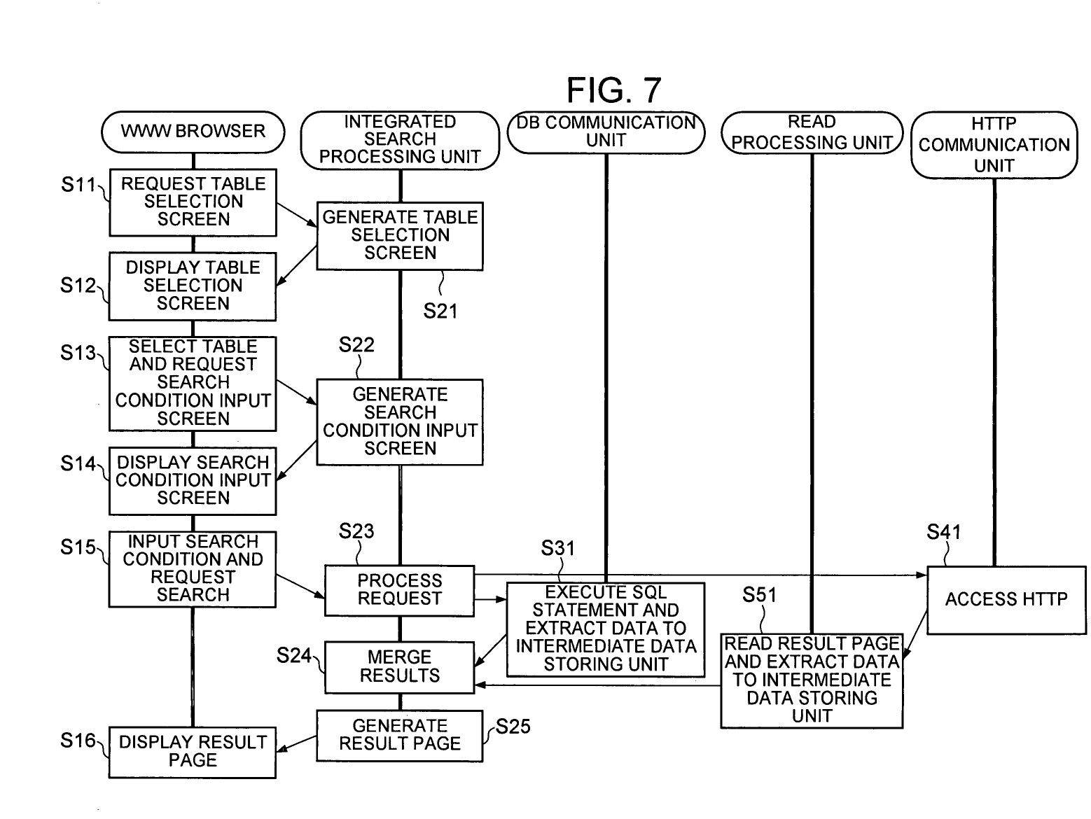

FIG. 7 is a flow describing the process procedure of the integrated search processing device 10 together with process procedure of the WWW browser 20. Hereinafter, in this embodiment, generating an HTML document used for a screen to be displayed on the display device of the WWW browser 20 is simply referred to as screen generation.

Upon reception of an instruction from the user, the WWW browser 20 requests the integrated search processing device 10 to generate the table selection screen 600, in order to select tables to be searched (S11). Specifically, this request is made by specifying a uniform resource locator (URL) of the table selection screen 600.

In the integrated search processing device 10, when the request from the WWW browser 20 is received via the client communication unit 13, the input screen generating unit 111 of the integrated search processing unit 11 generates the table selection screen 600 (S21).

The table selection screen 600 generated by the input screen generating unit 111 is returned to the WWW browser 20 via the client communication unit 13. The returned table selection screen 600 is displayed on the WWW browser 20 (S12). Upon reception of a selection of tables to be searched from the user via the displayed table selection screen 600, the WWW browser 20 sends, to the integrated search processing device 10, information to identify the selected tables and a request for provision of the search condition input screen 700 for the selected tables (S13). To be specific, when a click is made on the table selection button 600c, the WWW browser 20 sends the information to identify the tables, whose check boxes of the selection reception column 600a of the table selection screen 600 are checked, to the integrated search processing device 10, and requests the integrated search processing device 10 to provide the search condition input screen 700 for the selected tables.

In the integrated search processing device 10, when the request from the WWW browser 20 is received via the client communication unit 13, the input screen generating unit 111 of the integrated search processing unit 11 generates the search condition input screen 700 for all the selected tables by using the information held in the definition information holding unit 12 (S22). The generated search condition input screen 700 is returned to the WWW browser 20, which is a request source, via the client communication unit 13.

The WWW browser 20 displays the received search condition input screen 700 (S14).

The WWW browser 20 receives an input of a search condition from the user via the displayed search condition input screen 700. Then, the WWW browser 20 sends the received search condition and an instruction of search execution to the integrated search processing device 10 as request information (S15).

In the example of the search condition input screen 700 shown in FIG. 6, a condition value of “2004/01/21” for the OrderDate field 210b of the OrderManagementDB.OrderTable 210, which is received from the user, is displayed in addition to the initial values indicating the reference relationships which are already displayed at the time of the screen generation.

The request information, including the instruction of search execution, is sent to the integrated search processing device 10 when a click is made on the search execution button 700e of the search condition input screen 700. In the integrated search processing device 10, the integrated search processing unit 11 receives the request information via the client communication unit 13. Then, the request processing unit 112 controls the DB communication unit 15 and the HTTP communication unit 16 according to the information held in the definition information holding unit 12 and the request information to make requests to the DBMS 30, holding the database, and the WWW server 40, respectively (S23). Details of request processing which is performed after receiving the request information are described hereinafter.

First, the request processing performed with respect to the DBMS 30 is described. The request processing unit 112 uses the information held in the definition information holding unit 12 and the request information to generate an SQL statement according to a predetermined rule, and makes a request to the DBMS 30 with the SQL statement.

Specifically, the request processing unit 112 generates an SQL statement as follows. Field names selected in the display item selection column 700c are extracted from each database shown in the search condition input screen 700 and described following “SELECT” with “,” inserted therebetween. When there are fields, among fields other than those selected, that are specified as reference fields in the condition input column 700d, and if those specified fields belong to another database, those fields are also described following the fields that have already been described following “SELECT”, with “,” inserted therebetween. Further, when the same database has a table that includes a field that specifies a reference field, processing of fields following “SELECT”, described above, is continued also for the table including the field that specifies the reference field. After all target fields are described, “FROM” is described and then the names of the tables including the fields whose names have been described following “SELECT” are described with “,” inserted therebetween. Next, “WHERE” is described, and then “<field name>=<inputted condition value>” is described with respect to fields for which condition values are inputted, with “AND” inserted therebetween.

Note that if character strings of inputted condition values are described with “,” inserted therebetween, the character strings are regarded as specifying a condition for searching a plurality of items. In this case, “<field name>=<inputted condition value>” is replaced by “<field name> in <condition values inputted with “,” inserted therebetween>”. If character strings of inputted condition values are described before and after “-”, they are regarded as specifying a condition for searching the specified range. In this case, “<field name>=<inputted condition value>” is replaced by “<field name> between <character string described before “-”> AND <character string described after “-”>”. Further, if an inputted condition value includes “%”, it is regarded as a condition for searching by using the LIKE operator. In this case, “<field name>=<inputted condition value>” is replaced by “<field name> like <condition value including “%”>”.

Through the above-mentioned processing, the request processing unit 112 generates the following SQL statement upon reception of the request information shown in the search condition input screen 700 of FIG. 6: “SELECT OrderTable.OrderID,OrderTable.Orderer,OrderTable.OrderTotal,OrderDetailTable.Number,OrderDetailTable.Subtotal FROM OrderTable,OrderDetailTable WHERE OrderDetailTable.OrderID=OrderTable.OrderID AND OrderTable.OrderDate=2004/01/21”.

The generated SQL statement is passed to the DB communication unit 15. The DB communication unit 15 uses a database name, a URL, a driver name, a user name, and a password, which are specified in the information held in the definition information holding unit 12 to access the database held by the DBMS 30, and causes the generated SQL statement to be executed. After that, the DB communication unit 15 receives a table as a result of the execution and temporarily stores the table in the intermediate data holding unit 14 (S31).

Next, the request processing performed with respect to the WWW server 40 is described. The request processing unit 112 uses the information held in the definition information holding unit 12 and the request information to generate an HTTP request according to a predetermined rule, and accesses the WWW server 40. The request processing unit 112 generates an HTTP request parameter using data inputted in the condition input column 700d of the input table of the search condition input screen 700. For example, in a case where “PC” is inputted in the ProductID field of the input table corresponding to the condition input column 700d, since “id” is specified as the parameter name of the ProductID field in the example of the information held in the definition information holding unit 12 of FIG. 4, a parameter having a parameter name of “id” and a parameter value of “PC” is specified as the HTTP request parameter. When the HTTP request is sent to the WWW server 40, a telegraphic message including the HTTP request parameter is sent according to the HTTP protocol.

Used as the URL of a request destination is the URL specified in a URL column corresponding to the information record whose WWW name is ProductInformationWWW specified in the information held in the definition information holding unit 12. To be specific, in the example of the information held in the definition information holding unit 12 of FIG. 4, “http://www.shouhin.com” is used. The method specified in a method column is used as an HTTP method. In the example of the information held in the definition information holding unit 12 of FIG. 4, “POST” is used. Alternatively, other methods such as “GET” may also be used as the HTTP method.

Through the processing described above, the request processing unit 112 generates the HTTP request, and passes the HTTP request to the HTTP communication unit 16. The HTTP communication unit 16 sends the HTTP request to the WWW server 40 using the specified URL and other settings.

The HTTP communication unit 16 receives an HTML document as a result of the HTTP request, and passes the received HTML document to the read processing unit 17 (S41).

The read processing unit 17 analyzes the HTML document received from the HTTP communication unit 16 and temporarily stores the result of the analysis in the intermediate data holding unit 14. Further, if a value (i.e., input condition value) is inputted in the condition input column 700d of the search condition input screen 700 of FIG. 6 corresponding to a field of a table other than the input table, i.e., corresponding to the ProductName field 300b or the UnitPrice field 300c of the ProductInformationWWW.ProductTable 300, in the information held in the definition information holding unit 12 of FIG. 4, the read processing unit 17 stores in the intermediate data holding unit 14 only a record having the input condition value for this field among records which have been temporarily stored in the intermediate data holding unit 14 (S51). In other words, records that do not satisfy the condition are deleted.

Through the processing described above, the request processing with respect to the DBMS 30 or the WWW server 40 is completed. When the request processing unit 112 receives a processing completion notice, the merge processing unit 113 merges tables which are held in the intermediate data holding unit 14 through the request processing, based on the reference field specified in the condition input column 700d of the search condition input screen 700.

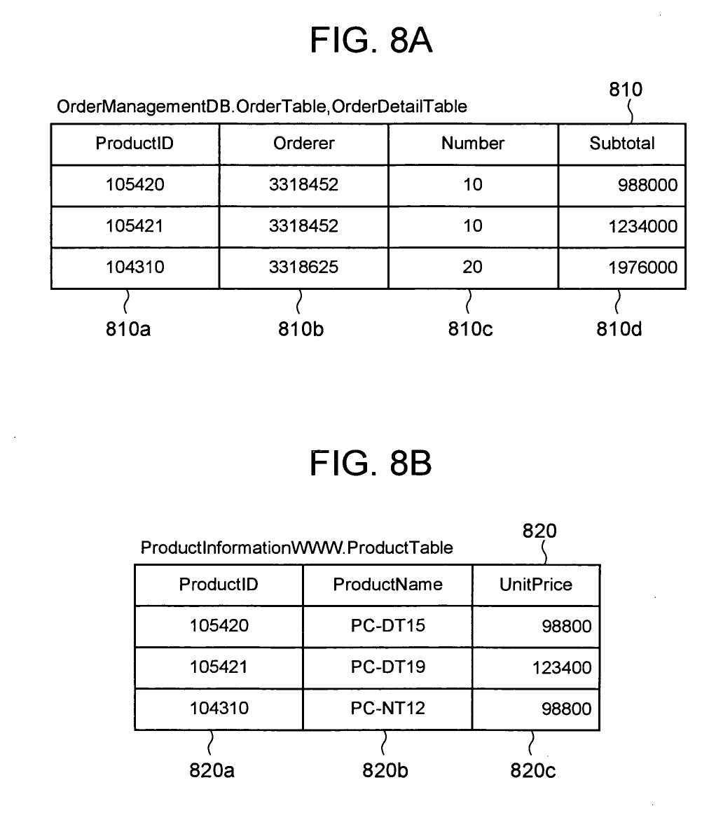

FIGS. 8A and 8B show tables held in the intermediate data holding unit 14 as request results. FIG. 8A shows an OrderManagementDB.OrderTable,OrderDetailTable 810 which is obtained as a result of the request to the DBMS 30. FIG. 8B shows a ProductInformationWWW.ProductTable 820 which is obtained as a result of the request to the WWW server 40.

When a field that is common to tables held in different databases or held by the WWW server 40 is referenced in the search condition input screen 700, the merge processing unit 113 extracts and merges the tables having the common field referenced (S24). In the example of the search condition input screen 700 of FIG. 6, a reference to OrderManagementDB.OrderDetailTable.ProductID is set in the condition input column 700d corresponding to the ProductID field of the ProductInformationWWW.ProductTable 300.

In the examples of the OrderManagementDB.OrderTable,OrderDetailTable 810 and the ProductInformationWWW.ProductTable 820 shown in FIGS. 8A and 8B, respectively, a ProductID field 810a of the OrderManagementDB.OrderTable,OrderDetailTable 810 which includes a result of searching the OrderManagementDB.OrderDetailTable 220 is to be referenced. The ProductID field 810a is used as a key to merge the OrderManagementDB.OrderTable,OrderDetailTable 810 and the ProductInformationWWW.ProductTable 820. After the merge, a table including only fields that are selected in the display item selection column 700c of the search condition input screen 700 as objects to be displayed is generated as a merge result.

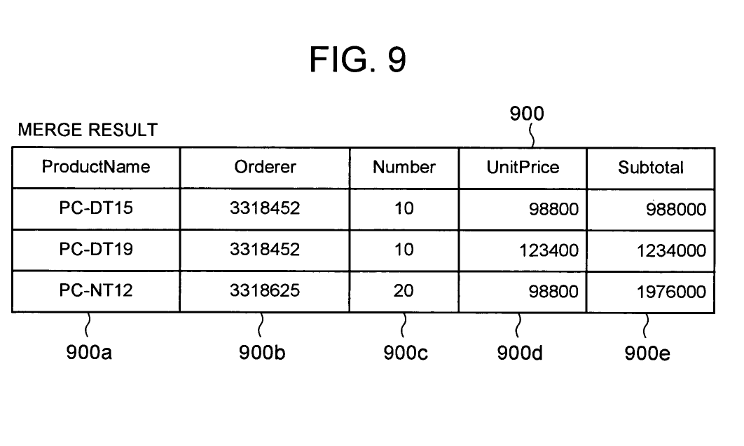

FIG. 9 shows an example of a merge result 900. The merge result 900 is a table which is obtained by merging the two tables shown in FIGS. 8A and 8B and includes only fields that are selected in the display item selection column 700c of the search condition input screen 700 as objects to be displayed.

Finally, the result screen generating unit 114 converts the merge result 900 from a table format to an HTML document format (S25), and sends an HTML document which is a result page generated through the conversion, to the WWW browser 20, which is the request source, via the client communication unit 13.

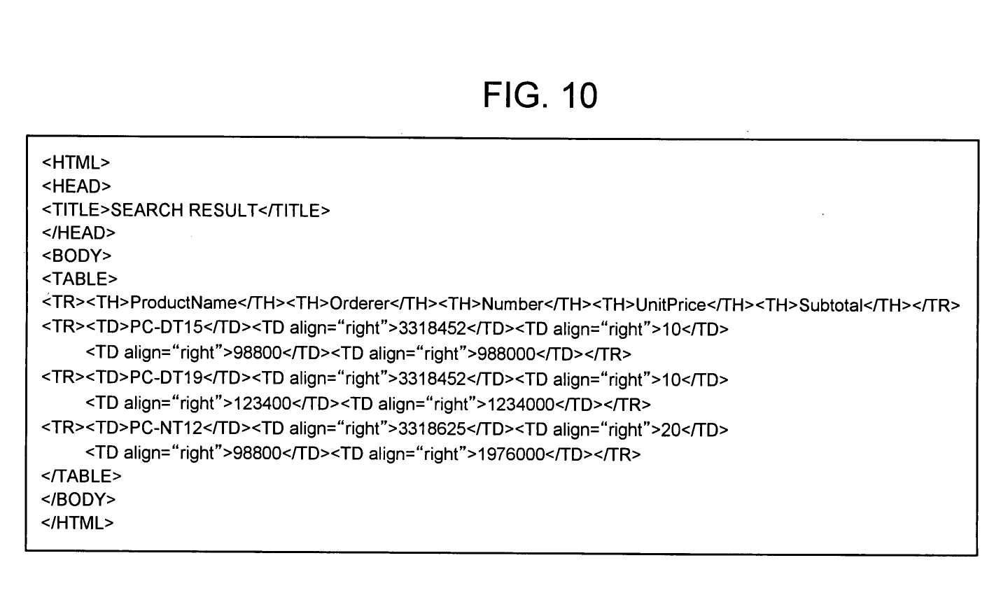

FIG. 10 shows an example of the merge result 900 of FIG. 9 converted to the HTML document format. In the merge result 900 in the HTML document format, a <TABLE> tag is used, <TH> tags are used to display the names of fields in the first line, and <TD> tags are used to display the values specified in the fields in each line. In addition, for a field whose field type is set to a numeric type in the information held in the definition information holding unit 12, an attribute of “align=“right”” is added to its <TD> tag to display a value right-aligned.

When receiving the HTML document of the merge result 900, the WWW browser 20 displays the HTML document on the screen to show the user the search result.

As described above, according to this embodiment, the user of the integrated search processing device 10 can integrally search information held by the DBMS 30 and that held by the WWW server 40 without distinguishing therebetween. By defining connection information of the DBMS 30 to be searched and the schema information, and connection information of the WWW server 40 to be searched and information of data on the WWW, an administrator of the integrated search processing device 10 can set the operations of the integrated search processing device 10 and provide the user with: the table selection screen 600, the search condition input screen 700, and screen data to display a result obtained through the search processing performed according to the search condition input screen 700.

As described above, in the conventional techniques, in order to integrally search a database held by a database server and information handled by a WWW application, it is necessary to develop a special program or system for accessing both the database and the information. However, according to this embodiment, it is possible to provide an environment in which an integrated search can be realized by merely defining information necessary to access both the database server and the WWW server and configuration information of data held by the database server and the WWW server. Accordingly, the burden on a developer can be reduced.

Therefore, according to this embodiment, the user can effectively perform an integrated search of a plurality of databases and information held by a plurality of WWW servers without distinguishing between the data structures of the databases and of the WWW servers. For example, with this embodiment, it is possible to easily provide a system for allowing an integrated search of business information which is stored at different locations in a company, such as information about order-receiving work, inventory management work, client management, and product management.

Further, according to this embodiment, it is possible to provide an environment in which the above-mentioned system for allowing an integrated search can be easily set by merely using definition information about data to be searched, so the number of processes which need to be performed by a developer of the integrated search system or an administrator of the integrated search system can be reduced.

What is claimed is:

1. An integrated search processing method which is performed by an integrated search processing device connected to a client, a plurality of databases, and a plurality of WWW servers,
the integrated search processing device holding definition information including: information which is used for connecting to the plurality of databases; configuration information on tables held by the plurality of databases; information which is used for connecting to the plurality of WWW servers; and configuration information on information held by the plurality of WWW servers;
the integrated search processing method comprising:
a table selection screen generating step of generating a table selection screen which is used for receiving from a user a selection of tables that can be integrally searched, by using the definition information, in response to a first request for a search made from the client, and which is to be displayed on a display device of the client that has made the first request, and sending the table selection screen to the client that has made the first request;
a search condition input screen generating step of generating a search condition input screen which is used for inputting a search condition for the selected tables by using the definition information in response to a second request from the client that has received a selection instruction from the user via the table selection screen, and which is to be displayed on a display device of the client that has made the second request, and sending the search condition input screen to the client that has made the second request;
a request processing step of generating a request command to request the search by using the definition information in response to a third request for the search from the client that has received an input of the search condition from the user via the search condition input screen, and sending the request command to the plurality of WWW servers and the plurality of databases which hold the tables to be searched;
an intermediate data holding step of holding, if the tables to be searched are held by the plurality of WWW servers, a search result returned in response to the request command, as intermediate data, after conversion into a format that allows merge processing, and further holding, if the tables to be searched are held by the plurality of databases, the search result returned in response to the request command, as the intermediate data;
a merge processing step of performing the merge processing on information held as the intermediate data, according to a condition specified in the third request; and
a result screen generating step of generating screen data which is used for displaying a result of the merge processing on the display device of the client that has made the third request, and sending the screen data to the client that that has made the third request.

2. An integrated search processing method according to claim 1, wherein the intermediate data holding step includes extracting, if the tables to be searched are held by the plurality of WWW servers, only information matching a condition specified in the request command, from the search result returned in response to the request command, and then converting the information into the format that allows the merge processing.

3. An integrated search processing method according to claim 1, wherein:
the definition information holds information on field types of fields constituting the respective tables, and field types of respective items of information held by the WWW servers; and
the result screen generating step includes generating the screen data based on the field types held in the definition information.

4. An integrated search processing device connected to a client, a plurality of databases, and a plurality of WWW servers, comprising:
a definition information holding unit which holds definition information including: information which is used for connecting to the plurality of databases; configuration information on tables held by the plurality of databases; information which is used for connecting to the plurality of WWW servers; and configuration information on information held by the plurality of WWW servers;
an input screen generating unit which generates a table selection screen which is used for receiving from a user a selection of tables that can be integrally searched, by using the definition information, in response to a first request for a search made from the client, and which is to be displayed on a display device of the client that has made the first request, sends the table selection screen to the client that has made the first request, further generates a search condition input screen which is used for inputting a search condition for the selected tables by using the definition information in response to a second request from the client that has received a selection instruction from the user via the table selection screen, and which is to be displayed on a display device of the client that has made the second request, and further sends the search condition input screen to the client that has made the second request;
a request processing unit which generates a request command to request the search, by using the definition information, in response to a third request for the search from the client that has received an input of the search condition from the user via the search condition input screen, and sends the request command to the plurality of WWW servers and the plurality of databases which hold the tables to be searched;
a reader unit which converts, if the tables to be searched are held by the plurality of WWW servers, a search result returned in response to the request command, into a format that allows merge processing;
an intermediate data holding unit which holds, if the tables to be searched are held by the plurality of databases, the search result returned in response to the request command, and further holds, if the tables to be searched are held by the plurality of WWW servers, the search result that has been converted by the reader unit;
a merge processing unit which performs the merge processing on information held in the intermediate data holding unit, according to a condition specified in the third request; and
a result screen generating unit which generates screen data which is used for displaying a result of the merge processing performed by the merge processing unit, on the display device of the client that has made the third request, and sends the screen data to the client that that has made the third request.

5. A program which is implemented for a computer serving as an integrated search processing device connected to a client, a plurality of databases, and a plurality of WWW servers, and holding definition information including: information which is used for connecting to the plurality of databases; configuration information on tables held by the plurality of databases; information which is used for connecting to the plurality of WWW servers; and configuration information on information held by the plurality of WWW servers,
the program causing the computer to function as:
an input screen generating unit which generates a table selection screen which is used for receiving from a user a selection of tables that can be integrally searched, by using the definition information, in response to a first request for a search made from the client, and which is to be displayed on a display device of the client that has made the first request, sends the table selection screen to the client that has made the first request, further generates a search condition input screen which is used for inputting a search condition for the selected tables, by using the definition information, in response to a second request from the client that has received a selection instruction from the user via the table selection screen, and which is to be displayed on a display device of the client that has made the second request, and further sends the search condition input screen to the client that has made the second request;
a request processing unit which generates a request command to request the search, by using the definition information, in response to a third request for the search from the client that has received an input of the search condition from the user via the search condition input screen, and sends the request command to the plurality of WWW servers and the plurality of databases which hold the tables to be searched;
a reader unit which converts, if the tables to be searched are held by the plurality of WWW servers, a search result returned in response to the request command, into a format that allows merge processing;
an intermediate data holding unit which holds, if the tables to be searched are held by the plurality of databases, the search result returned in response to the request command, and further holds, if the tables to be searched are held by the plurality of WWW servers, the search result that has been converted by the reader unit;
a merge processing unit which performs the merge processing on information held in the intermediate data holding unit, according to a condition specified in the third request; and
a result screen generating unit which generates screen data which is used for displaying a result of the merge processing performed by the merge processing unit, on the display device of the client that has made the third request, and sends the screen data to the client that that has made the third request.
